(19) United States
(12) Patent Application Publication
(10) Pub. No.: US 2010/0123820 A1
(43) Pub. Date: May 20, 2010

(54) LUMINANCE CONTROL SYSTEM AND RELATED CONTROL METHOD

(76) Inventor: Chih-Fa Tsai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/369,663

(22) Filed: Feb. 11, 2009

(30) Foreign Application Priority Data
Nov. 19, 2008 (TW) 097144647

(51) Int. Cl. H04N 5/225

(52) U.S. Cl. 348/370; 348/E05.024

(57) ABSTRACT

A luminance control system includes a light-emitting module including at least one light-emitting unit, a sensing device for sensing an ambient environment to generate a sensing output, and an image processing apparatus coupled to the sensing device and the light-emitting module for receiving the sensing output, and alternatively turning on and turning off the light-emitting unit to control a luminance of the light-emitting unit according to the sensing output.

### BACKGROUND OF THE INVENTION

1. Field of the Invention

The present invention relates to a luminance control system and related method, and more particularly to a luminance control system for a light-emitting diode on a webcam and related control method.

2. Description of the Prior Art

Notebook computers normally include a webcam. An image sensing device of the webcam senses an ambient luminance signal to generate a sensing signal, which is passed to an image signal processor (ISP) to generate an image signal. The webcam further includes a light for adjusting ambient luminance. This ambient luminance adjusting light provides a light source for the image sensing device to sense the ambient luminance signal under an appropriate ambient luminance. In other words, the ambient luminance adjusting light provides a base luminance such that the image sensing device senses the ambient luminance signal with more precise resolution. Normally, the ambient luminance adjusting light is implemented by a light-emitting diode (LED), and the light-emitting diode is controlled by a predetermined current generated by the image signal processor of the webcam. More specifically, the predetermined current is outputted from a pin of the image signal processor, and the predetermined current flows to a resistor to generate a driving signal to drive the light-emitting diode. Therefore, the luminance of the light-emitting diode is restricted by the resistance of the resistor. Conventionally, to overcome the above-mentioned shortcoming, the resistor is replaced by a variable resistor. However, an opening on the housing of the notebook computer is required because of the variable resistor. The opening is required to access a control terminal of the variable resistor, wherein the control terminal of the variable resistor is exposed to the user through the opening. The user is required to adjust the resistance of the variable resistor through the opening via the control terminal. The creation of the opening and adjustment procedures increase the cost relates to the use of the webcam.

In addition, the user always determines whether the webcam is in an activated state or inactivated state according to an activation indicator installed beside the webcam. The activation indicator is also implemented by a light-emitting diode. If the luminance generated by the light-emitting diode under the activated state is a fixed value, the user will be unable to clearly identify if the webcam is in the activated state or the inactivated state in a bright environment. Furthermore, the user may feel uncomfortable in a dark environment because of the offending luminance generated by the light-emitting diode.

Therefore, providing a low cost ambient luminance adjusting light and a low cost activation indicator having the functionality to adjust their luminance according to the ambient luminance for the webcam would be beneficial to the webcam field.

### SUMMARY OF THE INVENTION

One of the objectives of the present invention is therefore to provide a luminance control system of a light-emitting diode on a webcam and related control method.

According to an embodiment of the present invention, a luminance control system is disclosed. The luminance control system comprises a light-emitting module, a sensing device, and an image processing apparatus. The light-emitting module comprises at least one light-emitting unit. The sensing device senses an ambient environment to generate a sensing output. The image processing apparatus is coupled to the sensing device and the light-emitting module for receiving the sensing output, and alternatively turning on and turning off the light-emitting unit to control a luminance of the light-emitting unit according to the sensing output.

According to another embodiment of the present invention, a luminance control method is disclosed. The luminance control method comprises the steps of: providing a light-emitting module comprising at least one light-emitting unit; sensing an ambient environment to generate a sensing output; and alternatively turning on and turning off the light-emitting unit to control a luminance of the light-emitting unit according to the sensing output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a luminance control system according to an embodiment of the present invention.

FIG. 2 is a timing diagram illustrating a pulse width modulation signal generated by an image processing apparatus as shown in FIG. 1.

FIG. 3 is a diagram illustrating a luminance control system according to a second embodiment of the present invention.

FIG. 4 is a timing diagram illustrating the pulse width modulation signal generated by the image processing apparatus as shown in FIG. 3.

FIG. 5 is a flowchart illustrating a luminance control method according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

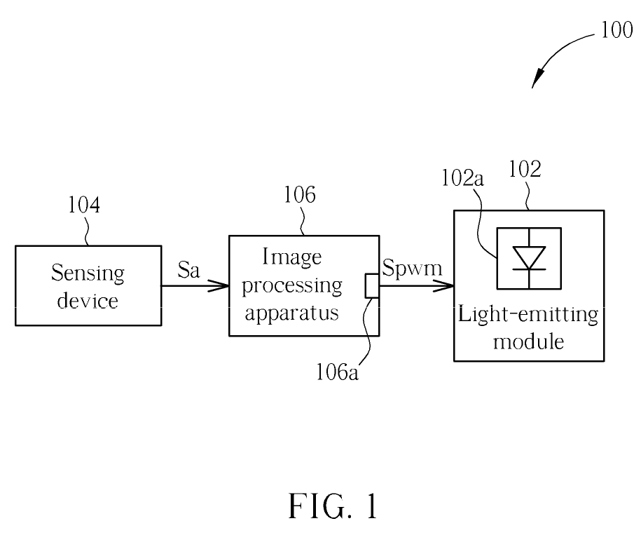

Please refer to FIG. 1. FIG. 1 is a diagram illustrating a luminance control system 100 according to an embodiment of the present invention. The luminance control system 100 comprises a light-emitting module 102, a sensing device 104, and an image processing apparatus 106. The light-emitting module 102 may be a light-emitting diode (LED) module, or other light-emitting modules. The light-emitting module 102 comprises at least a light-emitting unit. The light-emitting unit may be a light-emitting diode 102a or another type of light-emitting unit. Please note that, the light-emitting diode module as shown in FIG. 1 and described in the following description only serve as embodiments of the light-emitting module of the present invention and are not intended to limit the present invention. Also, the light-emitting diode as shown in FIG. 1 and described in the following description only serve as embodiments of the light-emitting unit of the present invention and are not intended to limit the present invention. The sensing device 104 senses an ambient environment to generate a sensing output Sa. The image processing apparatus 106 is coupled to the sensing device 104 and the light-emitting module 102 for receiving the sensing output Sa, and for alternatively turning on and turning off the light-emitting diode 102a to control a luminance of the light-emitting diode 102a according to the sensing output Sa. Please note that the luminance control system 100 of the present invention is applicable to a webcam system of a notebook computer. In addition, the light-emitting module 102 may be an ambient luminance adjusting light, and the ambient luminance adjusting light provides a light source for the sensing device 104 such that the sensing device 104 senses the light source of the ambient environment under an appropriate luminance.

Since the luminance control system 100 of the present invention alternatively turns on and turns off the light-emitting diode 102a to control the luminance of the light-emitting diode 102a under the theory of persistence of vision, any type of control signal with the characteristic of alternatively turning on and turning off the light-emitting diode 102 also belongs to the scope of the present invention. In one embodiment, the image processing apparatus 106 generates a pulse width modulation (PWM) signal Spwm to the light-emitting module 102 to adjust the luminance of the light-emitting diode 102a according to the sensing signal Sa. In addition, the present invention is not limited by the type of the sensing device 104. That is, any sensing device which has the ability to sense the ambient environment and generate a sensing image are within the scope of the present invention. For example, the sensing device 104 in this embodiment is a charge-coupled device, and the sensing device 104 in another embodiment is a complementary metal-oxide semiconductor sensor. In addition, the image processing device 106 comprises a general purpose input/output (GPIO) pin 106a, which is coupled to the light-emitting module 102, for outputting the pulse width modulation signal Spwm to the light-emitting module 102.

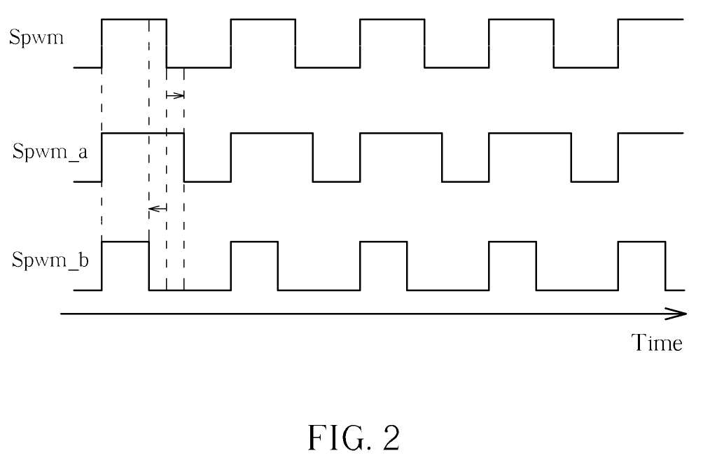

According to one embodiment of the present invention, when the webcam system is activated, the image processing apparatus 106 executes firmware. Then, the image processing apparatus 106 transmits the pulse width modulation signal Spwm having a specific frequency to the light-emitting module 102 via the general purpose input/output pin 106a. According to the sensing output Sa, when the image processing apparatus 106 determines that the luminance of the ambient environment is changed, the image processing apparatus 106 varies the duty cycle of the pulse width modulation signal Spwm to adjust the luminance of the light-emitting diode 102a as shown in FIG. 2. FIG. 2 is a timing diagram illustrating the pulse width modulation signal Spwm generated by the image processing apparatus 106 as shown in FIG. 1. When the image processing apparatus 106 determines that the luminance of the ambient environment is getting darker, the image processing apparatus 106 widens the pulse width of the pulse width modulation signal Spwm to generate a pulse width modulation signal Spwm_a to increase the luminance of the light-emitting diode. Alternatively, when the image processing apparatus 106 determines that the luminance of the ambient environment is getting lighter, the image processing apparatus 106 narrows the pulse width of the pulse width modulation signal Spwm to generate a pulse width modulation signal Spwm_b to decrease the luminance of the light-emitting diode. Accordingly, the resolution of the sensing device 104 used for sensing the light source from the ambient environment can be set more precisely. Please note that the pulse width modulation signal Spwm of the present invention is not limited to a pulse signal having a fixed frequency. In other embodiments, the image processing apparatus 106 also adjusts the frequency of the pulse width modulation signal Spwm to adjust the luminance of the light-emitting diode when the image processing apparatus 106 determines that the luminance of the ambient environment has changed.

In addition, the present invention is not limited by the signal characteristic (kind) of the sensing output Sa, which is utilized for determining the luminance variation of the ambient environment. In one embodiment, the sensing output Sa is a sensing image generated by the sensing device 104 by sensing the ambient environment, and the image processing apparatus 106 controls the alternating turning on and off of the light-emitting diode 102a according to the edge characteristic of the sensing image. In another embodiment of the present invention, the sensing output Sa is a sensing luminance generated by the sensing device 104 by sensing the ambient luminance. Furthermore, in yet another embodiment of the present invention, the sensing output Sa is an average sensing luminance generated by the sensing device 104 by sensing the ambient luminance.

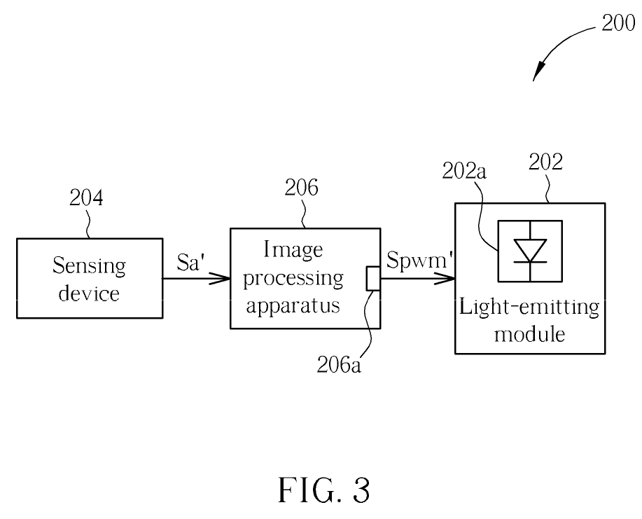

Please refer to FIG. 3. FIG. 3 is a diagram illustrating a luminance control system 200 according to a second embodiment of the present invention. The luminance control system 200 comprises a light-emitting module 202, a sensing device 204, and an image processing apparatus 206. The light-emitting module 202 may be a light-emitting diode (LED) module, or other light-emitting modules. The light-emitting module 202 comprises at least a light-emitting unit. The light-emitting unit may be a light-emitting diode 202a, or other light-emitting unit. Please note that the light-emitting diode module as shown in FIG. 3 and described in the following description only serves as embodiments of the light-emitting module of the present invention and are not intended to limit the present invention. Also, the light-emitting diode as shown in FIG. 3 and described in the following description only serve as embodiments of the light-emitting unit of the present invention and are not intended to limit the present invention. The sensing device 204 senses an ambient environment to generate a sensing output Sa′. The image processing apparatus 206 is coupled to the sensing device 204 and the light-emitting module 202 for receiving the sensing output Sa′, and alternatively turning on and turning off the light-emitting diode 202a to control a luminance of the light-emitting diode 202a according to the sensing output Sa′. Please note that the luminance control system 200 of the present invention is applicable in a webcam system of a notebook computer. In addition, the light-emitting module 202 may be an activation indicator of the webcam system, wherein the activation indicator provides a visual signal to inform the user that the webcam is in an activated state.

Since the luminance control system 200 of this embodiment is similar to the luminance control system 100 as shown in FIG. 1, a description of the detailed elements and related signals of the luminance control system 200 is omitted herein for brevity. A difference between the luminance control system 200 and the luminance control system 100 is the light-emitting module 202, which in this embodiment is the activation indicator of the webcam. Therefore, the following description only focuses on the adjusting operation between the image processing apparatus 206 and the light-emitting diode 202a. Furthermore, a person with ordinary skill in the art should understand the operation of the rest of the luminance control system 200 after reading the disclosure related to the luminance control system 100.

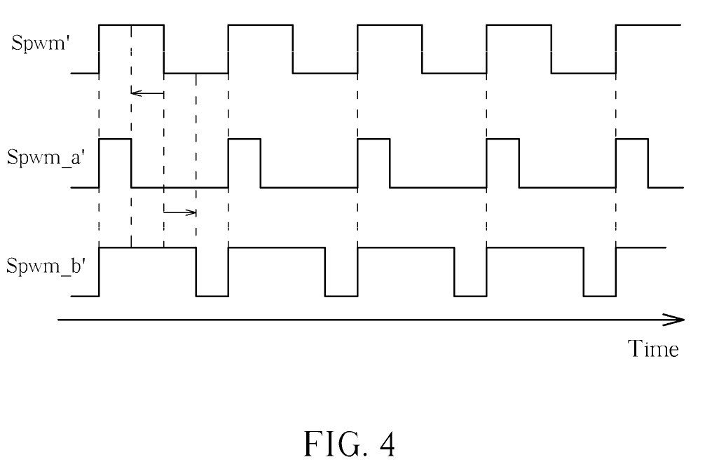

According to this embodiment of the present invention, when the webcam system is activated, the image processing apparatus 206 executes firmware. Then, the image processing apparatus 206 transmits the pulse width modulation signal Spwm having a specific frequency to the light-emitting module 202 via the general purpose input/output pin 206a. According to the sensing output Sa′, when the image processing apparatus 206 determines that the luminance of the ambient environment has changed, the image processing apparatus 206 varies the duty cycle of the pulse width modulation signal Spwm′ to adjust the luminance of the light-emitting diode 202a as shown in FIG. 4. FIG. 4 is a timing diagram illustrating the pulse width modulation signal Spwm′ generated by the image processing apparatus 206 as shown in FIG. 3. When the image processing apparatus 206 determines that the luminance of the ambient environment is getting darker, the image processing apparatus 206 narrows the pulse width of the pulse width modulation signal Spwm′ to generate a pulse width modulation signal Spwm_a′ to decrease the luminance of the light-emitting diode. Alternatively, when the image processing apparatus 206 determines that the luminance of the ambient environment is getting lighter, the image processing apparatus 106 widens the pulse width of the pulse width modulation signal Spwm′ to generate a pulse width modulation signal Spwm_b′ to increase the luminance of the light-emitting diode. Accordingly, the user is capable of determining whether the webcam is in an activated state or an inactivated state under any ambient luminance.

Please note that a person with ordinary skill in the art should appreciate that the ambient luminance adjusting light and the activation indicator may be installed on the same webcam through the appropriate modifications performed upon the luminance control systems 100 and 200.

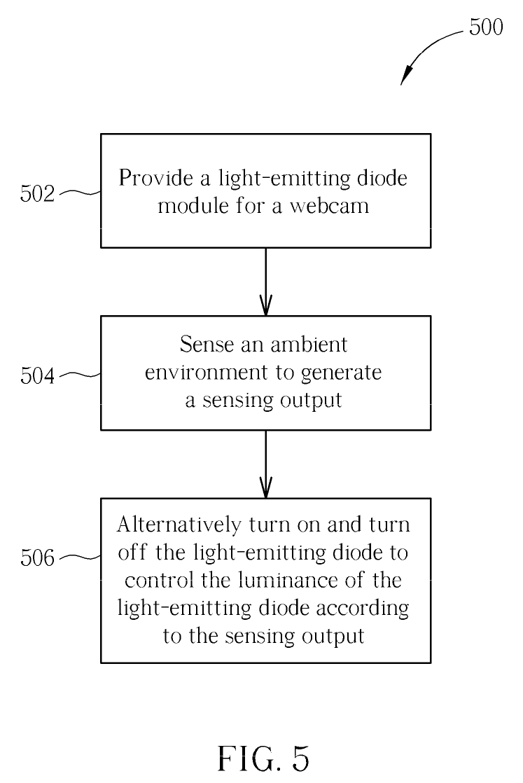

According to the above-mentioned embodiments, the luminance control method 500 of the luminance control systems 100 and 200 can be simplified in FIG. 5. FIG. 5 is a flowchart illustrating a luminance control method 500 according to an embodiment of the present invention. Please note that the light-emitting diode module in the following description only serves as an embodiment of the light-emitting module of the present invention and is not intended to limit the present invention. Likewise, the light-emitting diode in the following description only serves as an embodiment of the light-emitting unit of the present invention and is not intended to limit the present invention. Furthermore, provided that substantially the same result is achieved, the steps of the flowchart shown in FIG. 5 need not be in the exact order shown and need not be contiguous, that is, other steps can be intermediate. The luminance control method 500 comprises the following steps:

Step 502: Provide a light-emitting diode module for a webcam, the light-emitting diode module comprising at least one light-emitting diode.

Step 504: Sense an ambient environment to generate a sensing output.

Step 506: Alternatively turn on and turn off the light-emitting diode to control the luminance of the light-emitting diode according to the sensing output.

In step 502, the light-emitting diode module is an ambient luminance adjusting light, an activation indicator of the webcam, or both the ambient luminance adjusting light and the activation indicator. In step 504, the sensing output represents an ambient luminance of the ambient environment. In step 506, a pulse width modulation signal is applied to alternatively turn on and off the light-emitting diode to control the luminance of the light-emitting diode. If the light-emitting diode module is the ambient luminance adjusting light, the duty cycle of the pulse width modulation signal is adjusted to increase the luminance of the light-emitting diode when the ambient luminance is getting darker, or to decrease the luminance of the light-emitting diode when the ambient luminance is getting lighter. On the other hand, if the light-emitting diode module is the activation indicator, the duty cycle of the pulse width modulation signal is adjusted to decrease the luminance of the light-emitting diode when the ambient luminance is getting darker, or to increase the luminance of the light-emitting diode when the ambient luminance is getting lighter.

Briefly, according to the theory of persistence of vision, the present invention alternatively turns on and off the light-emitting diode of the webcam to adjust the luminance of the light-emitting diode, which can reduce the cost of the ambient luminance adjusting light and the activation indicator of the webcam. In addition, by not using a variable resistor, the present invention further reduces the power consumption of the webcam.

Those skilled in the art will readily observe that numerous modifications and alterations of the device and method may be made while retaining the teachings of the invention.

What is claimed is:

1. A luminance control system, comprising:
a light-emitting module, comprising at least one light-emitting unit;
a sensing device, for sensing an ambient environment to generate a sensing output; and
an image processing apparatus, coupled to the sensing device and the light-emitting module, for receiving the sensing output, and alternatively turning on and turning off the light-emitting unit to control a luminance of the light-emitting unit according to the sensing output.

2. The luminance control system of claim 1, wherein the sensing device comprises a charge-coupled device.

3. The luminance control system of claim 1, wherein the sensing device comprises a complementary metal-oxide semiconductor sensor.

4. The luminance control system of claim 1, wherein the image processing apparatus generates a pulse width modulation (PWM) signal to the light-emitting module to adjust the luminance of the light-emitting unit according to the sensing output.

5. The luminance control system of claim 4, wherein the image processing apparatus determines a variation of an ambient luminance of the ambient environment according to the sensing output, and the image processing apparatus adjusts a duty cycle of the pulse width modulation signal to increase the luminance of the light-emitting unit when the ambient luminance decreases, or adjusts the duty cycle of the pulse width modulation signal to decrease the luminance of the light-emitting unit when the ambient luminance increases.

6. The luminance control system of claim 4, wherein the image processing apparatus determines a variation of an ambient luminance of the ambient environment according to the sensing output, and the image processing apparatus adjusts a duty cycle of the pulse width modulation signal to decrease the luminance of the light-emitting unit when the ambient luminance decreases, or adjusts the duty cycle of the pulse width modulation signal to increase the luminance of the light-emitting unit when the ambient luminance increases.

7. The luminance control system of claim 4, wherein the image processing apparatus comprises a general purpose input/output (GPIO) pin, coupled to the light-emitting module, for outputting the pulse width modulation signal to the light-emitting module.

8. The luminance control system of claim 4, wherein the image processing apparatus executes firmware to set up the pulse width modulation signal according to the sensing output received from the sensing device.

9. The luminance control system of claim 1, wherein the light-emitting unit comprises an activation indicator of a webcam.

10. The luminance control system of claim 1, wherein the light-emitting unit comprises an ambient luminance adjusting light.

11. The luminance control system of claim 1, wherein the sensing output is a sensing image corresponding to the ambient environment sensed by the sensing device, and the image processing apparatus controls the alternative turning on and turning off of the light-emitting unit according to an edge characteristic of the sensing image.

12. The luminance control system of claim 1, wherein the sensing device senses an ambient luminance of the ambient environment to generate the sensing output.

13. The luminance control system of claim 1, wherein the light-emitting module comprises a light-emitting diode (LED) module, and the light-emitting unit comprises a light-emitting diode.

14. A luminance control method, comprising:
providing a light-emitting module comprising at least one light-emitting unit;
sensing an ambient environment to generate a sensing output; and
alternatively turning on and turning off the light-emitting unit to control a luminance of the light-emitting unit according to the sensing output.

15. The luminance control method of claim 14, wherein the step of alternatively turning on and turning off the light-emitting unit comprises generating a pulse width modulation (PWM) signal to the light-emitting module to adjust the luminance of the light-emitting unit according to the sensing output.

16. The luminance control method of claim 15, wherein the step of alternatively turning on and turning off the light-emitting unit further comprises determining a variation of an ambient luminance of the ambient environment according to the sensing output, and adjusting a duty cycle of the pulse width modulation signal to increase the luminance of the light-emitting unit when the ambient luminance decreases, or adjusting the duty cycle of the pulse width modulation signal to decrease the luminance of the light-emitting unit when the ambient luminance increases.

17. The luminance control method of claim 15, wherein the step of alternatively turning on and turning off the light-emitting unit further comprises determining a variation of an ambient luminance of the ambient environment according to the sensing output, and adjusting a duty cycle of the pulse width modulation signal to decrease the luminance of the light-emitting unit when the ambient luminance decreases, or adjusting the duty cycle of the pulse width modulation signal to increase the luminance of the light-emitting unit when the ambient luminance increases.

18. The luminance control method of claim 14, wherein the light-emitting unit comprises an activation indicator of a webcam.

19. The luminance control method of claim 14, wherein the light-emitting unit comprises an ambient luminance adjusting light.

20. The luminance control method of claim 14, wherein the sensing output is a sensing image corresponding to the ambient environment, and the step of alternatively turning on and turning off the light-emitting unit comprises controlling the alternative turning on and turning off of the light-emitting unit according to an edge characteristic of the sensing image.

21. The luminance control method of claim 14, wherein the step of sensing the ambient environment comprises sensing an ambient luminance of the ambient environment to generate the sensing output.
